(19) United States
(12) Patent Application Publication
(10) Pub. No.: US 2016/0261841 A1
(43) Pub. Date: Sep. 8, 2016

(54) METHOD AND DEVICE FOR SYNTHESIZING THREE-DIMENSIONAL BACKGROUND CONTENT

(71) Applicant: Samsung Electronics Co., Ltd., Suwon-si (KR)

(72) Inventors: Bonnie MATHEW, Bangalore (IN); In-su SONG, Suwon-si (KR); Pramod BELEKARE NAGARAJA SATHYA, Bangalore (IN); Ashish KUMAR, Bangalore (IN)

(21) Appl. No.: 15/061,152

(22) Filed: Mar. 4, 2016

(30) Foreign Application Priority Data
Mar. 5, 2015 (IN) 1091/CHE/2015
Feb. 25, 2016 (KR) 10-2016-0022829

(51) Int. Cl. H04N 13/00; H04N 13/04

(52) U.S. Cl. CPC H04N 13/004; H04N 13/0429; H04N 13/0497; H04N 13/0059

(57) ABSTRACT

A method and a device for synthesizing three-dimensional (3D) background content and application content are provided. The method includes receiving the application content from an external device connected to the device, generating the output stereoscopic content by synthesizing the application content and the 3D background content including at least one of a 3D stereoscopic video and a 3D stereoscopic image, and transmitting the generated output stereoscopic content to the external device. The generating of the output stereoscopic content includes disposing the application content to be displayed in a first region of a display of the external device and disposing the 3D background content to be displayed in a second region of the display.

### CROSS-REFERENCE TO RELATED APPLICATION(S)

This application claims the benefit under 35 U.S.C. §119(a) of an Indian provisional patent application filed on Mar. 5, 2015 in the Indian Patent Office and assigned Serial number 1091/CHE/2015, of an Indian regular patent application filed on Dec. 22, 2015 in the Indian Patent Office and assigned Serial number 1091/CHE/2015, and of a Korean patent application filed on Feb. 25, 2016 in the Korean Intellectual Property Office and assigned Serial number 10-2016-0022829, the entire disclosure of each of which is hereby incorporated by reference.

### TECHNICAL FIELD

The present disclosure relates to methods and devices for synthesizing three-dimensional (3D) background content. More particularly, the present disclosure relates to application synthesis for adding 3D background content capable of adding a 3D immersion effect to application content.

### BACKGROUND

Recently, device technology has been developed so that application content may be displayed seamlessly from two-dimensional (2D) display devices such as mobile phones and tablet personal computers (PCs) to three-dimensional (3D) display devices such as head-mounted display (HMD) devices and 3D televisions (TVs). Modification of application frames may be required in an application such as a video application or a photo application in which 3D background content may be synthesized to provide a 3D immersion effect when displayed seamlessly on a 3D display device. In particular, 2D non-stereoscopic frames may need to be modified by 3D parameters suitable for conversion into stereoscopic frames in order to provide a 3D immersion effect.

A synthesis method for adding 3D background content to application content may be specified by the feature of an application and the type of an external device connected to a device. In current methods, an application may be rewritten based on the type of a 3D display device connected to a device. Thus, the current methods may require a lot of time to rewrite and develop the application and may fail to provide a high-quality user experience specified according to the connected 3D display device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and device for providing a three-dimensional (3D) immersion effect to a user by synthesizing 3D background content and application content to generate output stereoscopic content, and transmitting the generated output stereoscopic content to an external device to display the output stereoscopic content through the external device.

Additional aspects will be set forth in part in the description which follows and, in part, will be apparent from the description, or may be learned by practice of the presented embodiments.

In accordance with an aspect of the present disclosure, a method for synthesizing 3D background content and application content by a device is provided. The method includes receiving the application content from an external device connected to the device, wherein the application content includes two dimensional (2D) non-stereoscopic content, generating output stereoscopic content by synthesizing the application content and the 3D background content including at least one of a 3D stereoscopic video and a 3D stereoscopic image, and transmitting the generated output stereoscopic content to the external device. The generating of the output stereoscopic content includes disposing the application content to be displayed in a first region of a display of the external device and disposing the 3D background content to be displayed in a second region of the display.

For example, the generating of the output stereoscopic content may include disposing the 3D background content to surround the application content.

For example, the external device may include one of a head-mounted display (HMD) device and a 3D television (TV).

For example, the 3D background content may include at least one stereoscopic virtual reality (VR) image among a 3D game arena image, a 3D movie theater image, a 3D photo gallery image, a 3D music performance hall image, and a 3D sports arena image.

For example, the method may further include identifying a device type of the external device, wherein the synthesizing of the 3D background content may include adding at least one of the 3D stereoscopic video and the 3D stereoscopic image to the application content based on the identified device type of the external device.

For example, the external device may include an HMD device and may be identified as the HMD device and the generating of the output stereoscopic content may include rendering the application content such that a frame of the application content has a same shape as a lens of the HMD device, disposing the rendered application content in the first region corresponding to the lens among an entire region of the display of the HMD device, and disposing the 3D background content in the second region other than the first region among the entire region of the display.

For example, the external device may include a 3D TV and may be identified as the 3D TV and the generating of the output stereoscopic content may include performing a first rendering to convert the application content into 3D application content and performing a second rendering to convert the 3D application content such that the converted 3D application content is displayed in the first region of the display of the 3D TV.

For example, the method may further include analyzing an application content feature including at least one of an application type executing the application content, a number of image frames included in the application content, a frame rate, and information about whether a sound is output, wherein the generating of the output stereoscopic content may include synthesizing the application content and at least one of the 3D stereoscopic video and the 3D stereoscopic image corresponding to the application content based on the analyzed application content feature.

For example, the 3D background content may be stored in a memory of the device and the generating of the output stereoscopic content may include selecting at least one of the 3D background content among the 3D stereoscopic video and the 3D stereoscopic image stored in the memory and synthesizing the selected 3D background content and the application content.

For example, the method may further include receiving a user input for selecting at least one of the 3D stereoscopic video and the 3D stereoscopic image stored in the memory, wherein the generating of the output stereoscopic content may include synthesizing the application content and the 3D background content selected based on the user input.

In accordance with another aspect of the present disclosure, a device for synthesizing 3D background content is provided. The device includes a communicator configured to receive application content from an external device connected to the device, wherein the application content includes 2D non-stereoscopic content, and a controller configured to generate output stereoscopic content by synthesizing the application content and the 3D background content including at least one of a 3D stereoscopic video and a 3D stereoscopic image, dispose the application content to be displayed in a first region of a display of the external device, and dispose the 3D background content to be displayed in a second region of the display. The communicator transmits the generated output stereoscopic content to the external device.

For example, the controller may dispose the 3D background content in the second region surrounding the first region.

For example, the external device may include one of an HMD device and a 3D TV.

For example, the 3D background content may include at least one stereoscopic VR image among a 3D game arena image, a 3D movie theater image, a 3D photo gallery image, a 3D music performance hall image, and a 3D sports arena image.

For example, the controller may identify a device type of the external device, and the 3D background content may be synthesized by adding at least one of the 3D stereoscopic video and the 3D stereoscopic image to the application content based on the identified device type of the external device.

For example, the external device may include an HMD device and may be identified as the HMD device and the controller may be further configure to render the application content such that a frame of the application content has a same shape as a lens of the HMD device, dispose the rendered application content in the first region corresponding to the lens of the HMD device among an entire region of the display of the HMD device, and dispose the 3D background content in the second region other than the first region among the entire region of the display of the HMD device.

For example, the external device may include a 3D TV and may be identified as the 3D TV and the controller may be further configured to perform a first rendering to convert the application content into 3D application content, and perform a second rendering to convert the 3D application content such that the converted 3D application content is displayed in the first region of the display of the 3D TV.

For example, the controller may be further configured to analyze an application content feature including at least one of an application type executing the application content, the number of image frames included in the application content, a frame rate, and information about whether a sound is output, and synthesize the application content and at least one of the 3D stereoscopic video and the 3D stereoscopic image corresponding to the application content based on the analyzed application content feature.

For example, the device may further include a memory configured to store the 3D background content, wherein the controller may be further configured to select at least one of the 3D background content among the 3D stereoscopic video and the 3D stereoscopic image stored in the memory, and synthesize the selected 3D background content and the application content.

For example, the device may further include a user input interface configured to receive a user input for selecting at least one of the 3D stereoscopic video and the 3D stereoscopic image stored in the memory, wherein the controller may synthesize the application content and the 3D background content selected based on the user input.

In accordance with another aspect of the present disclosure, a non-transitory computer-readable recording medium stores a program that performs the above method when executed by a computer.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a conceptual diagram illustrating a method for synthesizing, by a device, three-dimensional (3D) background content and application content to generate output stereoscopic content and transmitting the output stereoscopic content to an external device connected to the device, according to an embodiment of the present disclosure;

FIG. 2 is a block diagram of a device according to an embodiment of the present disclosure;

FIG. 3 is a flow diagram illustrating a method for synthesizing, by a device, 3D background content and application content to generate output stereoscopic content, according to an embodiment of the present disclosure;

FIG. 4 is a flow diagram illustrating a method for synthesizing, by a device, 3D background content and application content based on the type of an external device, according to an embodiment of the present disclosure;

FIGS. 5A to 5E are diagrams illustrating a method for synthesizing, by a device, 3D background content and application content based on the feature of the application content, according to an embodiment of the present disclosure;

FIG. 6 is a flow diagram illustrating a method for synthesizing, by a device, 3D background content and application content when the device is connected with a head-mounted display (HID) device, according to an embodiment of the present disclosure;

FIGS. 7A and 7B are diagrams illustrating a method for synthesizing, by a device, 3D background content and application content based on the feature of the application content, according to an embodiment of the present disclosure;

FIG. 8 is a flow diagram illustrating a method for synthesizing, by a device, 3D background content and application content based on the feature of the application content, according to an embodiment of the present disclosure;

FIG. 9 is a block diagram of a device according to an embodiment of the present disclosure;

FIG. 10 is a diagram illustrating the relationship between application content and 3D background content synthesized by a device according to an embodiment of the present disclosure;

FIG. 11 is a block diagram of a device according to an embodiment of the present disclosure;

FIG. 12 is a flow diagram illustrating a method for synthesizing, by a device, 3D background content and application content, according to an embodiment of the present disclosure;

FIG. 13 is a block diagram of a device according to an embodiment of the present disclosure; and

FIG. 14 is a flow diagram illustrating a method for synthesizing, by a device, 3D background content and application content based on the identification information of a user using the device, according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the specification, when an element is referred to as being “connected” to another element, it may be “directly connected” to the other element or may be “electrically connected” to the other element with one or more intervening elements therebetween. Also, when something is referred to as “including” a component, another component may be further included unless specified otherwise.

Also, herein, a device may be, for example, but is not limited to, a mobile phone, a smart phone, a portable phone, a tablet personal computer (PC), a personal digital assistant (PDA), a laptop computer, a media player, a PC, a global positioning system (GPS) device, a digital camera, a game console device, or any other mobile or non-mobile computing device. In an embodiment of the present disclosure, the device may be, but is not limited to, a display device that displays two-dimensional (2D) non-stereoscopic application content.

Herein, an external device may be a display device that may display three-dimensional (3D) stereoscopic content. The external device may be, for example, but is not limited to, at least one of a head-mounted display (HMD) device, a wearable glass, and a 3D television (TV).

Also, herein, application content may be content that is received from the external device by the device and is displayed through an application performed by the external device. For example, the application content may include, but is not limited to, at least one of an image played by a photo application, a video played by a video application, a game played by a game application, and a music played by a music application.

Also, herein, 3D background content may be 3D stereoscopic content that is synthesized with the application content by the device. For example, the 3D background content may include, but is not limited to, at least one of a 3D stereoscopic image, a 3D stereoscopic video, and a 3D virtual reality (VR) image.

Hereinafter, the present disclosure will be described in detail with reference to the accompanying drawings.

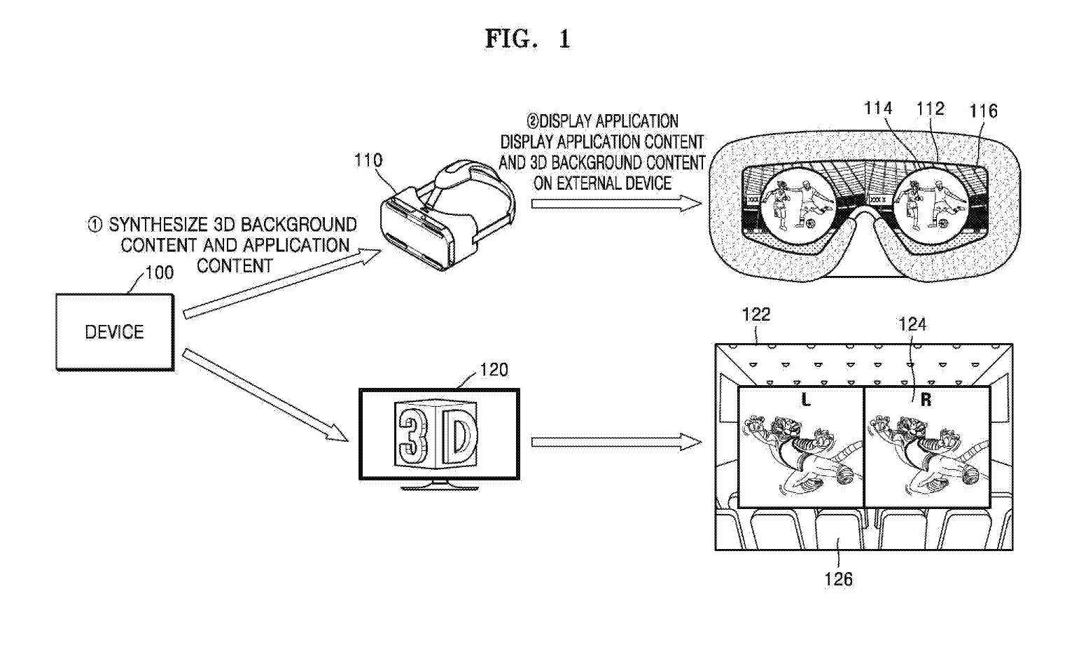

FIG. 1 is a conceptual diagram illustrating a method for synthesizing, by a device 100, 3D background content and application content to generate output stereoscopic content and transmitting the output stereoscopic content to an external device connected to the device, according to an embodiment of the present disclosure.

Referring to FIG. 1, the device 100 may be connected with external devices 110 and 120. In an embodiment of the present disclosure, the device 100 may be connected with an HMD device 110 or with a 3D TV 120. In an embodiment of the present disclosure, the device 100 may identify the device type or the type of the connected external devices 110 and 120.

The device 100 may receive application content from at least one external device 110 and 120. In an embodiment of the present disclosure, the device 100 may receive at least one of game content, image content, video content, and music content from the HMD device 110. In an embodiment of the present disclosure, the device 100 may receive 3D stereoscopic video content or 3D stereoscopic image content from the 3D TV 120. In an embodiment of the present disclosure, the application content may be, but is not limited to, 2D non-stereoscopic content.

The device 100 may add and synthesize the 3D background content and the application content received from the external devices 110 and 120. The device 100 may generate the output stereoscopic content including the 3D background content and the application content.

The device 100 may dynamically generate the output stereoscopic content suitable for the type of the external devices 110 and 120 through the application content synthesized with the 3D background content. Also, the device 100 may display the 3D background content and the application content on the external devices 110 and 120.

For example, when the HMD device 110 is connected to the device 100, the device 100 may dispose the application content to be displayed in a first region 114 of a display 112 of the HMD device 110 and dispose the 3D background content to be displayed in a second region 116 of the display 112 of the HMD device 110. The device 100 may perform a rendering for conversion such that the shape of an application content frame corresponds to the shape of a lens of the HMD device 110. In this case, the application content may be displayed in the first region 114 of the display 112 of the HMD device 110 corresponding to the shape of the lens of the HMD device 110.

For example, when connected to the 3D TV 120, the device 100 may render the application content that is 2D non-stereoscopic content into 3D application content. Also, the device 100 may dispose the 3D application content to be displayed in a first region 124 of a display 122 of the 3D TV 120 and dispose the 3D background content to be displayed in a second region 126 of the display 122 of the 3D TV 120.

In an embodiment of the present disclosure, based on the feature of the application content, the device 100 may generate the 3D background content added and synthesized with the application content. In another embodiment of the present disclosure, the device 100 may select at least one of the pre-stored 3D background content based on the feature of the application content received from the external devices 110 and 120. For example, when the application content is game content, the device 100 may analyze the number of frames of the game content, a frame rate, and the contents of the frames, select the 3D background content including a 3D crowd cheering image and a game arena image, and synthesize the selected 3D background content and the application content. Also, for example, when the application content is movie content, the device 100 may analyze the type of an application playing the movie content, select a 3D movie theater image, and synthesize the selected 3D movie theater image and the movie content.

The device 100 according to an embodiment of the present disclosure may provide a user with a 3D immersion effect on the application content by receiving the application content from the external devices 110 and 120 connected with the device 100 and adding/synthesizing the 3D background content and the application content. For example, when the HMD device 110 is connected to the device 100, the device 100 may provide the user with a 3D immersion effect as in a movie theater by displaying the movie content in the first region 114 of the display 112 of the HMD device 110 and simultaneously displaying a 3D theater image corresponding to the 3D background content in the second region 116 of the display 112 of the HMD device 110.

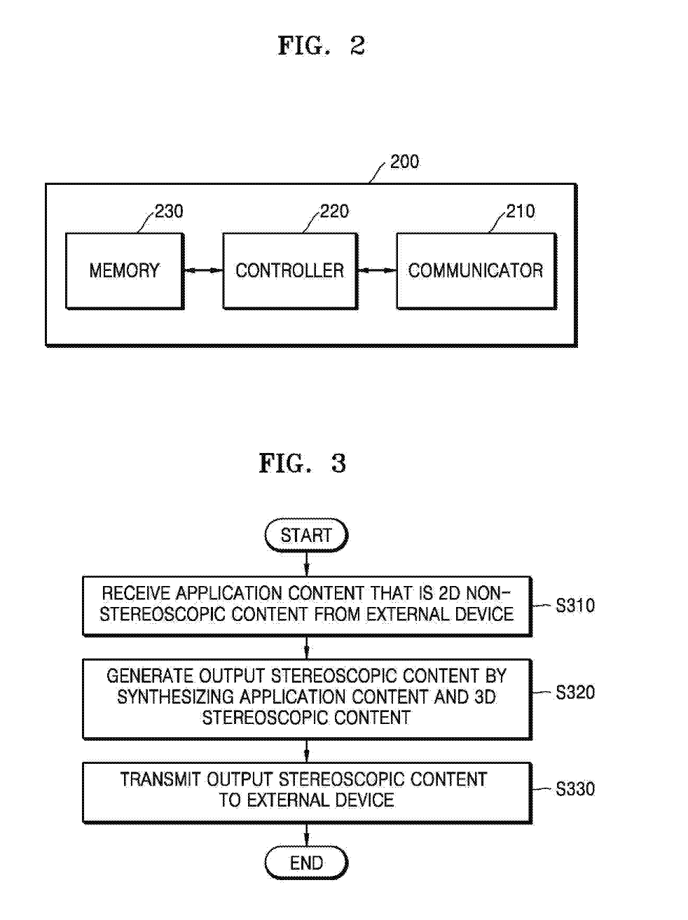

FIG. 2 is a block diagram of a device 200 according to an embodiment of the present disclosure.

Referring to FIG. 2, the device 200 may include a communicator 210, a controller 220, and a memory 230.

The communicator 210 may connect the device 200 to one or more external devices, other network nodes, Web servers, or external data servers. In an embodiment of the present disclosure, the communicator 210 may receive application content from the external device connected to the device 200. The communicator 210 may connect the device 200 and the external device wirelessly and/or by wire. The communicator 210 may perform data communication with the data server or the external device connected to the device 200 by using a wired communication method including a local area network (LAN), unshielded twisted pair (UTP) cable, and/or optical cable or a wireless communication method including a wireless LAN, cellular communication, device-to-device (D2D) communication network, Wi-Fi, Bluetooth, Bluetooth low energy (BLE), near field communication (NFC), and/or radio frequency identification (RFID) network.

In an embodiment of the present disclosure, the communicator 210 may receive the 3D background content selected by the controller 220 based on the feature of the application content.

The controller 220 may include a processor that is capable of operation processing and/or data processing for adding/synthesizing the 3D background content including at least one of a 3D stereoscopic video and a 3D stereoscopic image and the application content received by the communicator 210. The controller 220 may include one or more microprocessors, a microcomputer, a microcontroller, a digital signal processing unit, a central processing unit (CPU), a state machine, an operation circuit, and/or other devices capable of processing or operating signals based on operation commands. However, the controller 220 is not limited thereto and may also include the same type and/or different types of multi-cores, different types of CPUs, and/or a graphics processing unit (GPU) having an acceleration function. In an embodiment of the present disclosure, the controller 220 may execute software including an algorithm and a program module that are stored in the memory 230 and executed by a computer.

The controller 220 may generate the output stereoscopic content including the 3D background content and the application content by synthesizing the 3D background content and the application content received from the external device. In an embodiment of the present disclosure, the controller 220 may dispose the application content to be displayed in the first region of the display of the external device and dispose the 3D background content to be displayed in the second region of the display of the external device. In an embodiment of the present disclosure, the controller 220 may synthesize the application content and the 3D background content such that the 3D background content is displayed in the second region surrounding the application content on the display of the external device. The controller 220 may add/synthesize the 3D background content and the application content by using the software (e.g., a window manager and an application surface compositor) included in an operating system (OS) stored in the memory 230.

The controller 220 may identify the type of the external device connected to the device 200 and add/synthesize the application content and at least one of the 3D background content including the 3D stereoscopic video and the 3D stereoscopic image based on the identified type of the external device. In an embodiment of the present disclosure, when the external device connected to the device 200 is an HMD device, the controller 220 may dispose the application content in the first region having the same shape as the lens of the HMD device among the entire region of the display of the HMD device and dispose the 3D background content in the second region other than the first region among the entire region of the display of the HMD device.

The controller 220 may render the application content that is 2D non-stereoscopic content into the 3D stereoscopic content. In an embodiment of the present disclosure, when the external device connected to the device 200 is a 3D TV, the controller 220 may perform a first rendering to convert the application content into the 3D application content and perform a second rendering to convert the 3D application content such that the converted 3D application content is displayed in the first region of the display of the 3D TV.

The memory 230 may store software, program modules, or algorithms including codes and instructions required to implement the tasks performed by the controller 220, for example, a task of synthesizing the application content and the 3D background content, a task of 3D-rendering the 2D non-stereoscopic application content, and a task of determining the regions in which the application content and the 3D background content are displayed on the display of the external device.

The memory 230 may include at least one of volatile memories (e.g., dynamic random access memories (DRAMs), static RAMs (SRAMs), and synchronous DRAMs (SDRAMs)), non-volatile memories (e.g., read only memories (ROMs), programmable ROMs (PROMs), one-time PROMs (OTPROMs), erasable and programmable ROMs (EPROMs), electrically erasable and programmable ROMs (EEPROMs), mask ROMs, and flash ROMs), hard disk drives (HDDs), and solid state drives (SSDs). In an embodiment of the present disclosure, the memory 230 may include a database.

In an embodiment of the present disclosure, for example, the memory 230 may store a 3D stereoscopic image and a 3D stereoscopic video. Herein, the 3D stereoscopic image and the 3D stereoscopic video may be an image and a video of a type that is preset based on the feature of the application content. For example, the 3D stereoscopic image stored in the memory 230 may be a stereoscopic VR image including at least one of a 3D game arena image, a 3D movie theater image, a 3D photo gallery image, a 3D music performance hall image, and a 3D sports arena image. For example, the 3D stereoscopic video stored in the memory 230 may be a stereoscopic VR video including a 3D crowd cheering video and a 3D music performance hall play video.

FIG. 3 is a flow diagram illustrating a method for synthesizing, by a device, 3D background content and application content to generate 3D output content, according to an embodiment of the present disclosure.

Referring to FIG. 3, in operation S310, the device may receive application content that is 2D non-stereoscopic content from an external device. In an embodiment of the present disclosure, the device may receive the application content from the external device connected to the device wirelessly and/or by wire. The external device may be, for example, but is not limited to, an HMD device or a 3D TV. The application content may include, as 2D non-stereoscopic content, at least one of movie content played by a video player application, game content played by a game application, image content played by a photo application, and music content played by a music application.

In operation S320, the device may generate output stereoscopic content by synthesizing the application content and 3D stereoscopic content.

In an embodiment of the present disclosure, the device may dispose the application content to be displayed in the first region of the display of the external device and dispose the 3D background content to be displayed in the second region of the display of the external device. In an embodiment of the present disclosure, the device may dispose the 3D background content to surround the application content.

The device may select at least one of the 3D background content among the 3D stereoscopic video and the 3D stereoscopic image from the external data server or the memory in the device, receive the selected 3D background content from the external data server or the memory, and synthesize the received 3D background content and the application content.

In operation S330, the device may transmit the output stereoscopic content to the external device. The output stereoscopic content may include the application content and the 3D stereoscopic content. The external device may receive the output stereoscopic content from the device, display the application content among the output stereoscopic content in the first region of the display, and display the 3D background content in the second region of the display.

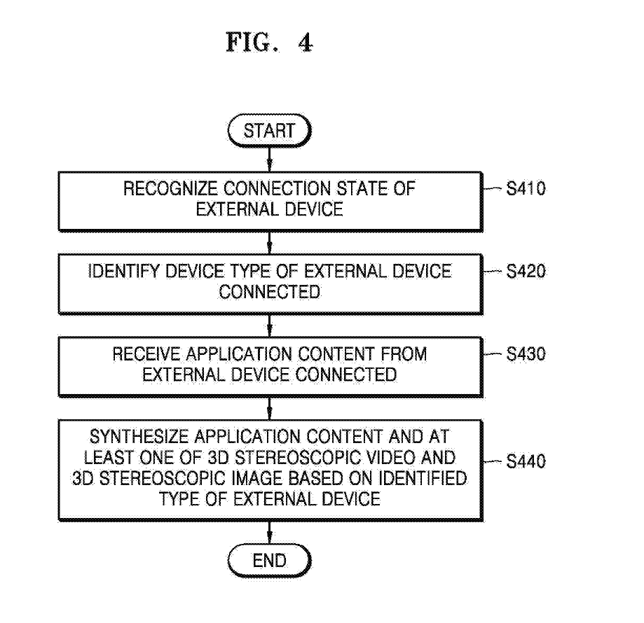

FIG. 4 is a flow diagram illustrating a method for synthesizing, by a device, 3D background content and application content based on the device type of an external device, according to an embodiment of the present disclosure.

Referring to FIG. 4, in operation S410, the device may recognize a connection state of the external device. The device may periodically recognize the connection state with the external device. In an embodiment of the present disclosure, the device may recognize the external device connected to the device and may use a VR helper service capable of representing the recognized external device. In an embodiment of the present disclosure, when recognizing that the external device is not connected thereto, the device may not perform an operation of receiving the application content or synthesizing the 3D background content.

In operation S420, the device may identify the device type of the external device connected thereto. When recognizing that the external device is connected to the device in operation S410, the device may identify the device type of the external device. In an embodiment of the present disclosure, the device may identify the device type of the external device connected to the device by using a VR helper service. The device may acquire, for example, the identification information of the external device including at least one of the subsystem identification (SSID) of the external device, the model name of the external device, the performance information of the external device, the device type of the application content executed by the external device, and the display device type of the external device.

In an embodiment of the present disclosure, the device may identify an HMD device or a 3D TV as the external device. However, the external device that may be identified by the device is not limited thereto.

In operation S430, the device may receive the application content from the external device connected thereto. In an embodiment of the present disclosure, the application content may be, but is not limited to, 2D non-stereoscopic content. In an embodiment of the present disclosure, the device may receive the application content from the external device connected thereto wirelessly and/or by wire.

In operation S440, the device may synthesize the application content and at least one of the 3D stereoscopic video and the 3D stereoscopic image based on the identified device type of the external device. The device may add, for example, a stereoscopic VR image including at least one of a 3D game arena image, a 3D movie theater image, a 3D photo gallery image, a 3D music performance hall image, and a 3D sports arena image to the application. Also, the device may add, for example, a stereoscopic VR video including a 3D crowd cheering video and a 3D music performance hall play video to the application content.

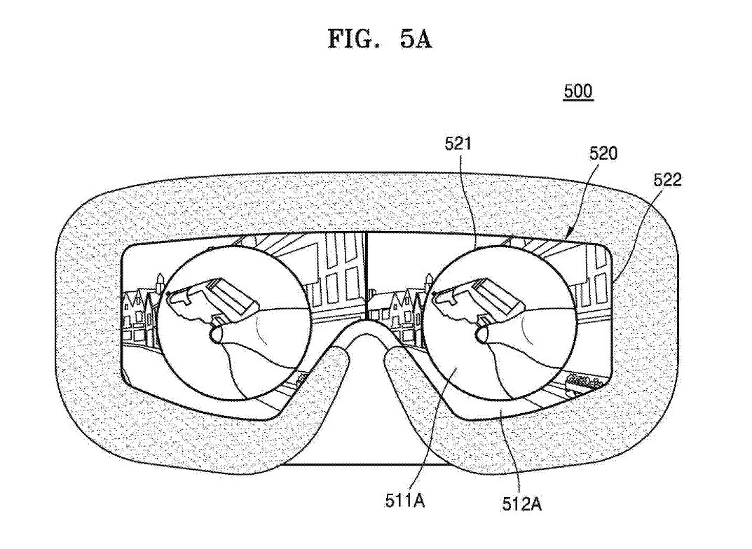

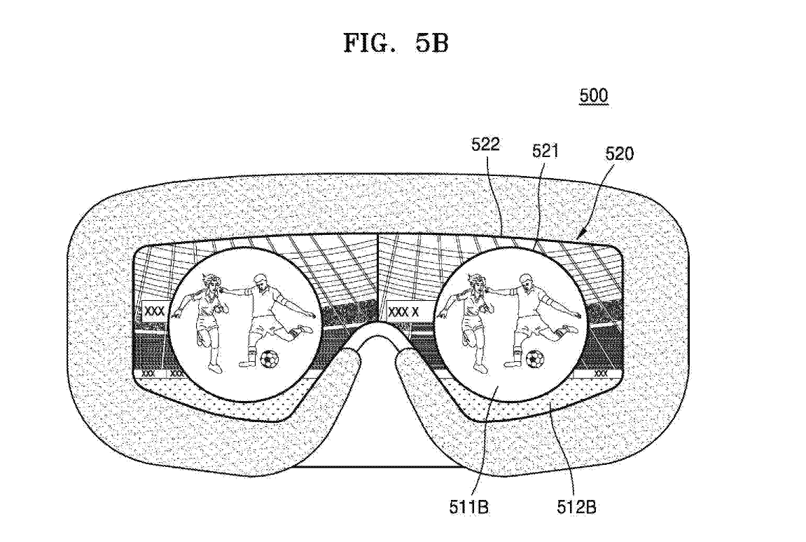

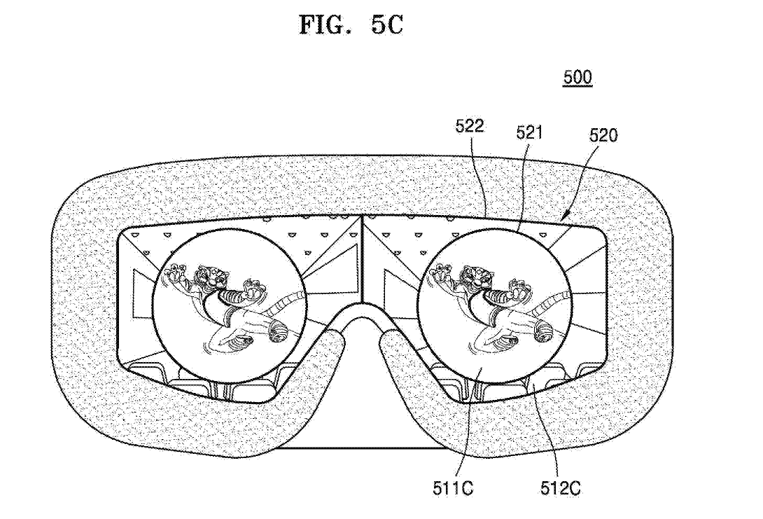

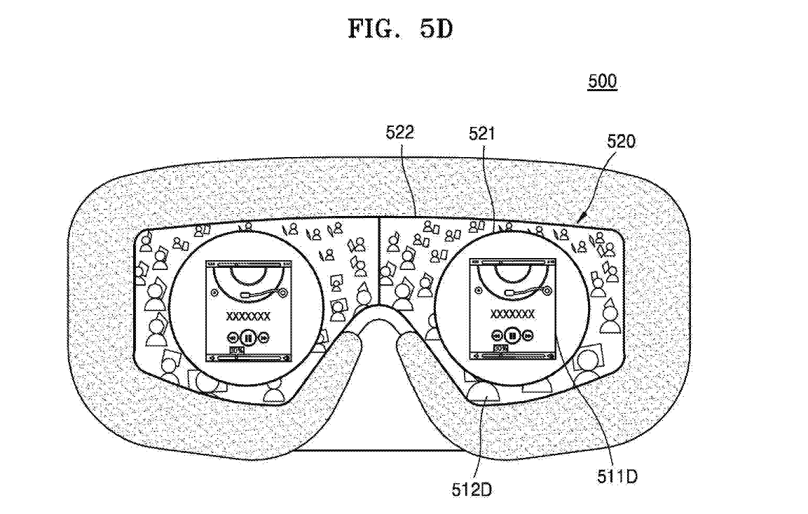

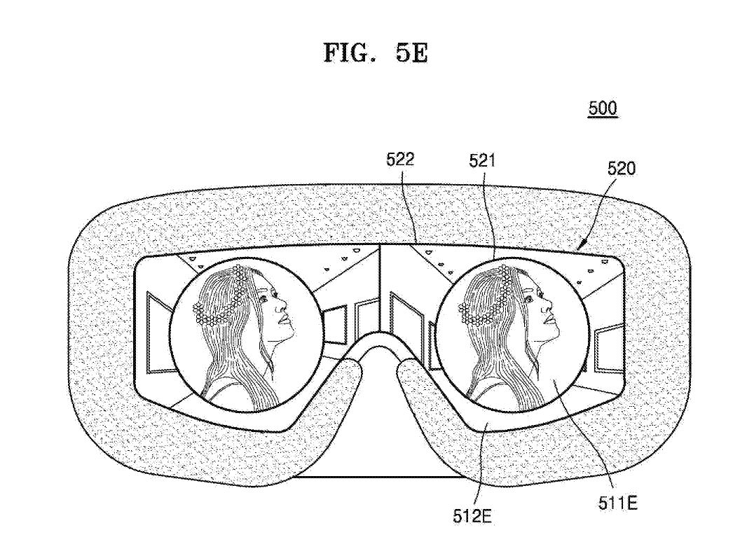

The device may synthesize the 3D background content and the application content differently based on the device type of the external device connected to the device, for example, the case where the external device is an HMD device or the case where the external device is a 3D TV. This will be described later in detail with reference to FIGS. 5A to 8.

FIGS. 5A to 5E are diagrams illustrating a method for synthesizing, by a device, 3D background content and application content based on the feature of the application content, according to an embodiment of the present disclosure.

Referring to FIG. 5A, when connected with an HMD device 500, the device may receive game content 511A from the HMD device 500, synthesize the received game content 511A and 3D background content 512A to generate output stereoscopic content, and transmit the generated output stereoscopic content to the HMD device 500. The HMD device 500 may display the output stereoscopic content on a display 520.

In an embodiment of the present disclosure, the device may render the game content 511A such that the shape of a frame of the game content 511A may be identical to the shape of a first region 521 corresponding to the shape of an eyepiece lens among the entire region of the display 520 of the HMD device 500. That is, the device may perform a lens correction for rendering the game content 511A such that a frame of the game content 511A having a tetragonal shape may be modified into a round shape of the first region 521 of the display 520 of the HMD device 500.

Also, the device may synthesize the game content 511A and the 3D background content 512A corresponding to the game content 511A. In an embodiment of the present disclosure, when recognizing the game content 511A, the device may analyze the feature of the game content 511A and synthesize the game content 511A and the 3D background content 512A suitable for the analyzed feature of the game content 511A. For example, when the game content 511A is a first person shooter (FPS) game, the device may synthesize the game content 511A and a battlefield background video or a battlefield stereoscopic image corresponding to the background of a game. In an embodiment of the present disclosure, the device may synthesize the game content 511A and a game arena image.

The device may dispose the 3D background content 512A, which is synthesized with the game content 511A, to be displayed in a second region 522 of the display 520 of the HMD device 500. The HMD device 500 may display the game content 511A in the first region 521 of the display 520 and display the 3D background content 512A synthesized by the device in the second region 522 of the display 520.

Referring to FIG. 5B, the device may receive sports game content 511B from the HMD device 500. The device may recognize the sports game content 511B, analyze the feature of the sports game content 511B, and synthesize the sports game content 511B and 3D background content 512B (e.g., a 3D arena image 512B) suitable for the analyzed feature of the sports game content 511B. Also, the device may synthesize the sports game content 511B and 3D crowd cheering video content 512B.

Referring to FIG. 5C, when connected with the HMD device 500, the device may receive movie content 511C from the HMD device 500, synthesize the received movie content 511C and 3D background content 512C to generate output stereoscopic content, and transmit the generated output stereoscopic content to the HMD device 500. The HMD device 500 may display the output stereoscopic content on the display 520.

When recognizing the movie content 511C played by a video application, the device may analyze the feature of the movie content 511C and synthesize the movie content 511C and 3D background content 512C (e.g., a 3D movie theater image 512C) suitable for the analyzed feature of the movie content 511C.

The device may dispose the 3D movie theater image 512C, which is synthesized with the movie content 511C, to be displayed in the second region 522 of the display 520 of the HMD device 500.

Except for the type of the application content (the movie content 511C) and the type of the synthesized 3D background content (the 3D movie theater image 512C), the features such as the disposition region of the 3D background content and the rendering of the application content performed by the device may be the same as those described with reference to FIG. 5A, and thus redundant descriptions thereof will be omitted for conciseness.

Referring to FIG. 5D, when connected with the HMD device 500, the device may receive music content 511D from the HMD device 500, synthesize the received music content 511D and a 3D music concert hall image 512D to generate output stereoscopic content, and transmit the generated output stereoscopic content to the HMD device 500. The HMD device 500 may display the output stereoscopic content on the display 520.

When recognizing the music content 511D played by a music application, the device may analyze the feature of the music content 511D and synthesize the music content 511D and 3D background content 512D (e.g., a 3D music concert hall image 512D) suitable for the analyzed feature of the music content 511D. In another embodiment of the present disclosure, the device may synthesize the music content 511D and a 3D music play video 512D.

The device may dispose the 3D music concert hall image 512D, which is synthesized with the music content 511D, to be displayed in the second region 522 of the display 520 of the HMD device 500.

Except for the type of the application content (the music content 511D) and the type of the synthesized 3D background content (the 3D music concert hall image 512D), the features such as the disposition region of the 3D background content and the rendering of the application content performed by the device may be the same as those described with reference to FIG. 5A, and thus redundant descriptions thereof will be omitted for conciseness.

Referring to FIG. 5E, when connected with the HMD device 500, the device may receive photo content 511E played by a photo application from the HMD device 500, synthesize the received photo content 511E and a 3D photo gallery image 512E to generate output stereoscopic content, and transmit the generated output stereoscopic content to the HMD device 500. The HMD device 500 may display the output stereoscopic content on the display 520.

When recognizing the photo content 511E played by the music application, the device may analyze the feature of the photo content 511E and synthesize the photo content 511E and 3D background content 512E (e.g., a 3D photo gallery image 512E) suitable for the analyzed feature of the photo content 511E.

The device may dispose the 3D photo gallery image 512E, which is synthesized with the photo content 511E, to be displayed in the second region 522 of the display 520 of the HMD device 500.

Except for the type of the application content (the photo content 511E) and the type of the synthesized 3D background content (the 3D photo gallery image 512E), the features such as the disposition region of the 3D background content and the rendering of the application content performed by the device may be the same as those described with reference to FIG. 5A, and thus redundant descriptions thereof will be omitted for conciseness.

According to the embodiments of the present disclosure illustrated in FIGS. 5A to 5E, when connected with the HMD device 500, the device may render the application content such that the shape of the frame of the application content, that is, the shape of the frame may be identical to the round shape of the first region 521 of the display 520 corresponding to the lens of the HMD device 500, and synthesize the 3D background content and the application content such that the 3D background content may be displayed in the second region 522 of the display 520 of the HMD device 500.

In general, the HMD device 500 may be connected with a VR lens of the HMD device 500 and a mobile phone. In this case, a frame of the application content displayed by the mobile phone may be rendered roundly by a binocular magnifier distortion of the VR lens, and an outer portion of the VR lens may be blacked out. According to the various embodiments of the present disclosure, the device may display the 3D background content in the blackout region, that is, the second region 522 illustrated in FIGS. 5A to 5E, thereby making it possible to provide a 3D stereoscopic immersion effect or a 3D stereoscopic immersion effect to the user that views the application content or plays the game.

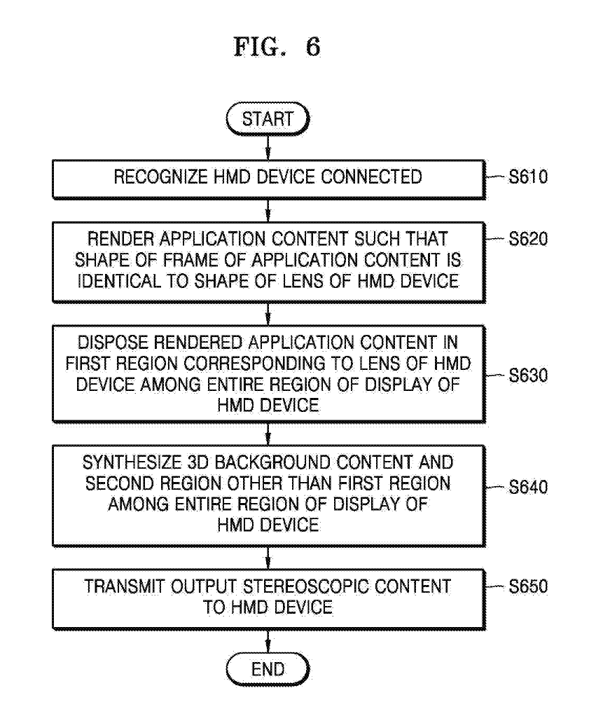

FIG. 6 is a flow diagram illustrating a method for synthesizing, by a device, 3D background content and application content when the device is connected with an HMD device, according to an embodiment of the present disclosure.

Referring to FIG. 6, in operation S610, the device may recognize an HMD device connected to the device. In an embodiment of the present disclosure, the device may obtain at least one identification information among the SSID of the HMD device, the model name of the HMD device, the performance information of the HMD device, and the display type information of the HMD device and recognize the HMD device based on the obtained identification information.

In operation S620, the device may render the application content such that the shape of the frame of the application content may be identical to the shape of the lens of the HMD device. In an embodiment of the present disclosure, the device may perform a lens correction for rendering the frame of the application content such that the frame of the application content having a tetragonal shape may be modified into the round shape of the lens of the display of the HMD device.

In operation S630, the device may dispose the rendered application content in the first region corresponding to the lens of the HMD device among the entire region of the display of the HMD device.

In operation S640, the device may synthesize the 3D background content and the second region other than the first region among the entire region of the display of the HMD device. In an embodiment of the present disclosure, the device may analyze the feature of the application content received from the HMD device, select the 3D background content based on the analyzed feature of the application content, and synthesize the selected 3D background content and the application content. In an embodiment of the present disclosure, the device may synthesize the application content and the 3D background content such that the 3D background content may be displayed in the second region, that is, the blackout region other than the first region corresponding to the lens among the entire region of the display of the HMD device.

In operation S650, the device may transmit output stereoscopic content, which is generated by synthesizing the application content and the 3D background content, to the HID device. The HID device may display the output stereoscopic content on the display. In an embodiment of the present disclosure, the HID device may display the application content in the first region of the display and display the 3D background content in the second region of the display.

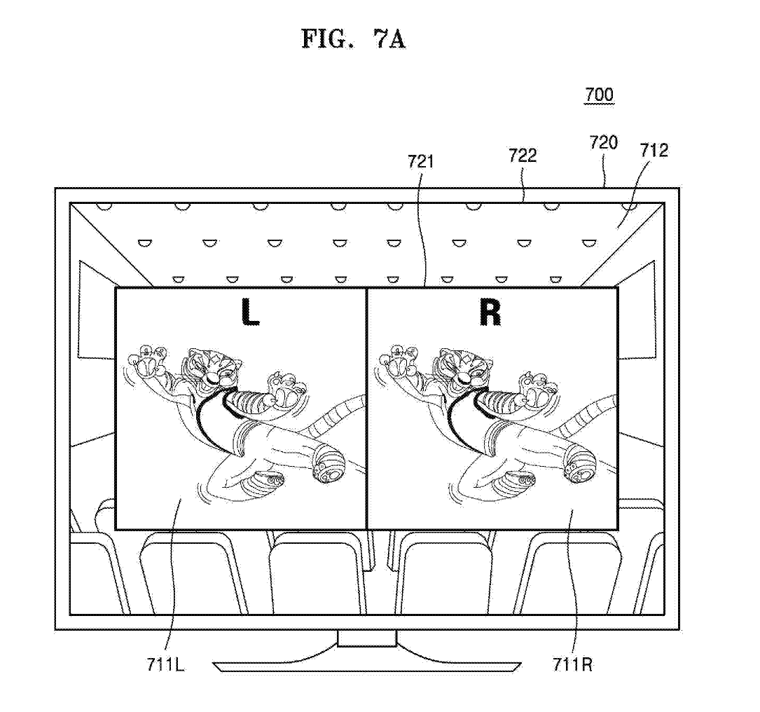

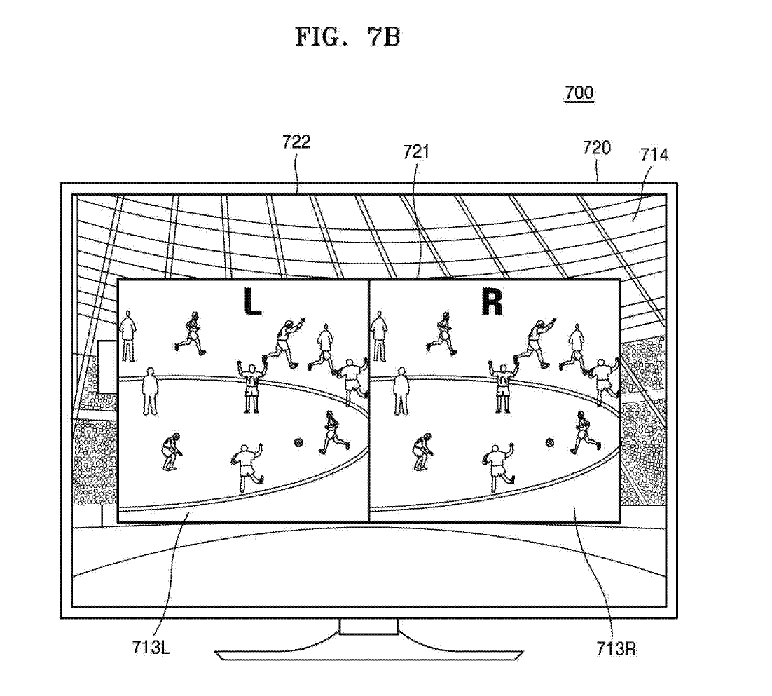

FIGS. 7A and 7B are diagrams illustrating a method for synthesizing, by a device, 3D background content and application content based on the feature of the application content, according to an embodiment of the present disclosure.

Referring to FIG. 7A, when connected with a 3D TV 700, the device may receive movie content from the 3D TV 700 and render the received movie content into 3D movie content. Also, the device may dispose the rendered 3D movie content to be displayed in a first region 721 of a display 720 of the 3D TV 700, and synthesize a 3D movie theater image 712 and the 3D movie content.

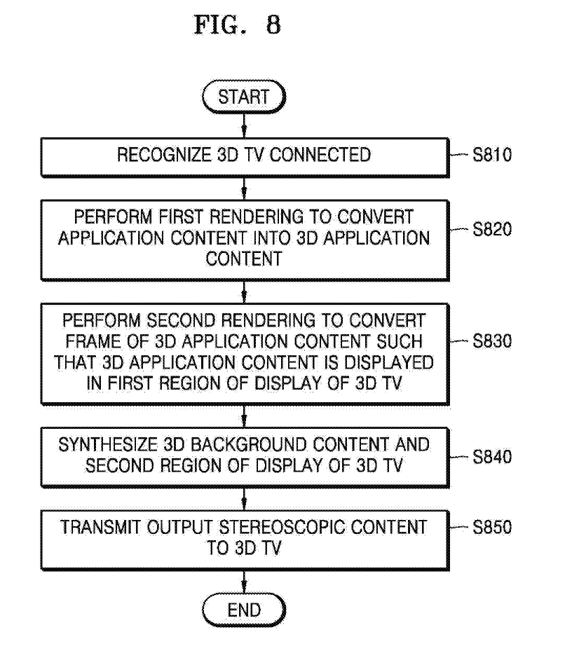

In an embodiment of the present disclosure, by using a binocular disparity of the image frames included in the 2D non-stereoscopic movie content received from the 3D TV 700, the device may generate a left-eye frame image 711L and a right-eye frame image 711R and convert the same into the 3D movie content. A method for conversion into the 3D movie content will be described later in detail with reference to FIG. 8.

In an embodiment of the present disclosure, the device may perform a rendering to modify the frame size of the 3D movie content 711L and 711R such that the frame of the 3D movie content 711L and 711R may be displayed in the first region 721 of the display 720 of the 3D TV 700.

Also, the device may analyze the feature of the 3D movie content 711L and 711R and synthesize the 3D movie content 711L and 711R and the 3D background content suitable for the analyzed feature of the 3D movie content 711L and 711R. For example, the device may synthesize and dispose the 3D background content (i.e., the 3D movie theater image 712) corresponding to the 3D movie content 711L and 711R in a second region 722 of the display 720 of the 3D TV 700.

Referring to FIG. 7B, the device may receive sports game content from the 3D TV 700 and convert the sports game content, which is 2D non-stereoscopic content, into 3D sports game content 713L and 713R. Also, the device may perform a rendering to modify the frame size of the 3D sports game content 713L and 713R such that the frame of the 3D sports game content 713L and 713R may be displayed in the first region 721 of the display 720 of the 3D TV 700.

In the embodiment of the present disclosure illustrated in FIG. 7B, the device may synthesize and dispose the 3D background content (i.e., a 3D arena image 713) corresponding to the 3D sports game content 713L and 713R in the second region 722 of the display 720 of the 3D TV 700. In an embodiment of the present disclosure, the device may synthesize and dispose a 3D crowd cheering video corresponding to the 3D sports game content 713L and 713R in the second region 722 of the display 720 of the 3D TV 700.

The device may transmit the output stereoscopic content including the synthesized 3D application content 711L, 711R, 713L, and 713R and the 3D background content 712 and 714 to the 3D TV 700. The 3D TV 700 may display the 3D application content 711L, 711R, 713L, and 713R in the first region 721 of the display 720 and display the synthesized 3D background content 712 and 714 in the second region 722 of the display 720.

According to various embodiments of the present disclosure illustrated in FIGS. 7A and 7B, when connected with the 3D TV 700, the device may convert the application content that is 2D non-stereoscopic content into the 3D application content, synthesize the 3D background content and the 3D application content, and display the 3D background content and the 3D application content on the display 720 of the 3D TV 700. Thus, the device according to various embodiments of the present disclosure may provide a 3D stereoscopic immersion effect or a 3D stereoscopic reality effect even to a user viewing the 2D non-stereoscopic application content as if the user views a 3D movie in a movie theater or views a 3D sports game directly in a sports arena.

FIG. 8 is a flow diagram illustrating a method for synthesizing, by a device, 3D background content and application content based on the feature of the application content, according to an embodiment of the present disclosure.

Referring to FIG. 8, in operation S810, the device may recognize a 3D TV connected to the device. In an embodiment of the present disclosure, the device may obtain at least one identification information among the SSID of the 3D TV, the model name of the 3D TV, the performance information of the 3D TV, and the display type information of the 3D TV and recognize the 3D TV based on the obtained identification information.

In operation S820, the device may perform a first rendering to convert the application content into 3D application content. In an embodiment of the present disclosure, the device may convert the 2D non-stereoscopic application content into the 3D application content by selecting a key frame of the application content, extracting an object, allocating a depth, performing tracking, and performing a first rendering process.

In an application content key frame selecting operation, the device may determine a key frame among a plurality of frames of the 2D non-stereoscopic application content. In an embodiment of the present disclosure, among the plurality of frames of the 2D non-stereoscopic application frame, the frame representing the application content may be determined as the key frame.

In an object extracting operation, the device may extract an object on the determined key frame. The object may be an important object included in each frame. For example, when the application content is movie content, the object may be an image of a hero in a scene where the hero appears, or an image of a vehicle in a scene where the vehicle runs. In the object extracting operation, the device may segment an image of the frame and extract a boundary of the object from the segmentation result thereof.

In a depth allocating operation, the device may allocate a depth to the object extracted in the object extracting operation. The depth may be a parameter for providing a 3D visual effect, and it may be used to shift the object left and right by the allocated parameter value in the left-eye frame image and the right-eye frame image. In the depth allocating operation, the device may allocate the depth by using a preset template.

In a tracking operation, the device may generate the left-eye frame image and the right-eye frame image with respect to the other frames (other than the key frame) of the application content. The tracking operation may be performed with reference to the depth allocating operation and the object extracting operation performed on the key frame.

In a first rendering operation, the device may perform image processing for the completed 3D application content on the right-eye frame image and the left-eye frame image on which the depth allocation and the tracking have been performed. For example, in the rendering operation, the device may perform an inpainting process for filling an empty region caused by the object shift.

In operation S830, the device may perform a second rendering to convert the frame of the 3D application content such that the converted 3D application content may be displayed in the first region of the display of the 3D TV. In an embodiment of the present disclosure, by reducing or increasing the size of the frame of the 3D application content, the device may convert the 3D application content to be displayed in the first region of the display of the 3D TV. In an embodiment of the present disclosure, the device may dispose the 3D application content in the first region of the display of the 3D TV.

In operation S840, the device may synthesize the 3D background content in the second region of the display of the 3D TV. In an embodiment of the present disclosure, the device may analyze the feature of the 3D application content and synthesize the 3D application content and the 3D background content suitable for the analyzed feature of the 3D application content. In an embodiment of the present disclosure, the device may dispose the 3D application content in the first region of the display of the 3D TV and dispose the 3D background content in the second region of the display of the 3D TV to surround the 3D application content.

In operation S850, the device may transmit output stereoscopic content, which is generated by synthesizing the 3D application content and the 3D background content, to the 3D TV. The 3D TV may display the output stereoscopic content on the display. In an embodiment of the present disclosure, the 3D TV may display the 3D application content in the first region of the display and display the 3D background content in the second region of the display.

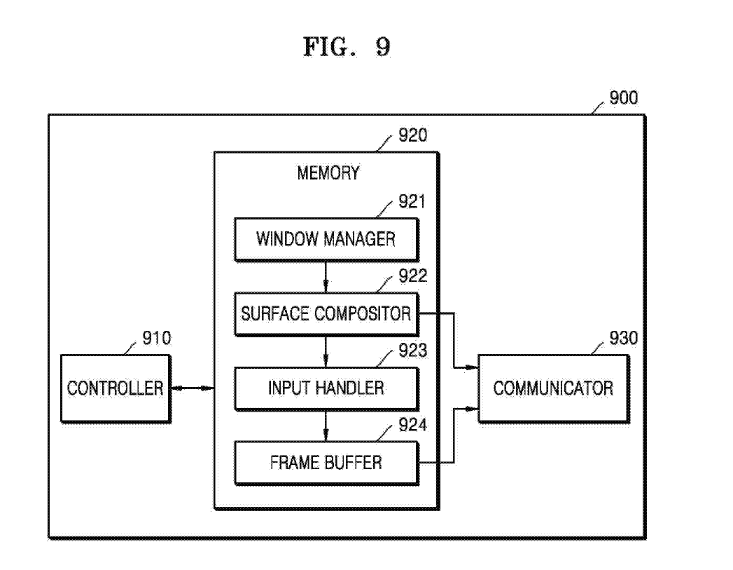

FIG. 9 is a block diagram of a device 900 according to an embodiment of the present disclosure.

Referring to FIG. 9, the device 900 may include a controller 910, a memory 920, and a communicator 930. Since the description of the controller 910 may partially overlap with the description of the controller 220 illustrated in FIG. 2 and the description of the communicator 930 may partially overlap with the description of the communicator 210 illustrated in FIG. 2, redundant descriptions thereof will be omitted and only differences therebetween will be described.

The controller 910 may include one or more microprocessors, a microcomputer, a microcontroller, a digital signal processor, a CPU, a graphic processor, a state machine, an operation circuit, and/or other devices capable of processing or operating signals based on operation commands. The controller 910 may execute software including an algorithm and a program module that are stored in the memory 920 and executed by a computer.

The memory 920 may store, for example, a data structure, an object-oriented component, a program, or a routine for executing a particular task, a function, or a particular abstract data type. In an embodiment of the present disclosure, the memory 920 may store a window manager 921, a surface compositor 922, an input handler 923, and a frame buffer 924. In an embodiment of the present disclosure, the surface compositor 922 may include a surface flinger.

The controller 910 may control windows such as visibility, application layouts, or application instructions through source codes or instructions of the window manager 921 stored in the memory 920. The window may be supported by the surface of an OS. The controller 910 may transmit a window surface to the surface compositor 922 through the window manager 921. The controller 910 may combine multiple buffers into a single buffer through the surface compositor 922.

The controller 910 may modify the 2D non-stereoscopic application content through a source code or an instruction included in the surface compositor 922. In an embodiment of the present disclosure, through the surface compositor 922, the controller 910 may modify the application content such that the application content may be displayed in a VR mode of the external device. In an embodiment of the present disclosure, the controller 910 may interact with the surface compositor 922 and the window manager 921 through a binder call.

The controller 910 may recognize whether the external device is connected to the device 900 through the window manager 921. In an embodiment of the present disclosure, the controller 910 may recognize whether the external device is connected to the device 900 by using a VR helper service. When recognizing that the external device is connected to the device 900, the controller 910 may read the source code or the instruction included in the window manager 921, display a VR tag through this, and transmit the same to the surface compositor 922.

Immediately when the surface compositor 922 receives the displayed VR tag, the controller 910 may identify the device type of the external device connected to the device 900. In an embodiment of the present disclosure, the controller 910 may obtain the identification information of the external device including at least one of the SSID of the external device, the model name of the external device, the performance information of the external device, the type of the application content executed by the external device, and the display type of the external device, and identify the device type of the external device based on the obtained identification information of the external device.

Based on the identified device type of the external device, by using the window manager 921 and the surface compositor 922, the controller 910 may synthesize the application content and the 3D background content to generate the output stereoscopic content.

Also, the controller 910 may perform rendering such that the output stereoscopic content may be displayed on the display of the external device through the frame buffer 924. In an embodiment of the present disclosure, by using the frame buffer 924, the controller 910 may perform rendering such that the application content may be displayed in the first region of the display of the external device and the 3D background content may be displayed in the second region of the display of the external device.

By using the input handler 923, the controller 910 may process an event from the external device connected to the device 900. An input gesture such as a touch gesture or a mouse movement may be received as an input event from the external device. For example, the input handler 923 may adjust sight line parameters from the surface compositor 922 based on a head tracking sensor attached to the HMD device. That is, by using the input handler 923, based on the head tracking information, the controller may check whether a zoom level is smaller than or equal to a threshold value and adjust the zoom level accordingly.

The window manager 921 and the surface flinger may be modules used in the Android OS, and may be software modules capable of synthesizing the 3D background content and the 2D non-stereoscopic application content.

In the embodiment of the present disclosure illustrated in FIG. 9, the device 900 reads the source code or the instruction included in the surface compositor 922 and the window manager 921 in the Android OS and synthesizes the 3D background content and the 2D non-stereoscopic application content accordingly. However, this is merely an example, and the present disclosure is not limited to the Android OS. Even in MS Windows, iOS, Tizen, and a particular game console OS, the device 900 may synthesize the 3D background content and the 2D application content to generate the output stereoscopic content.

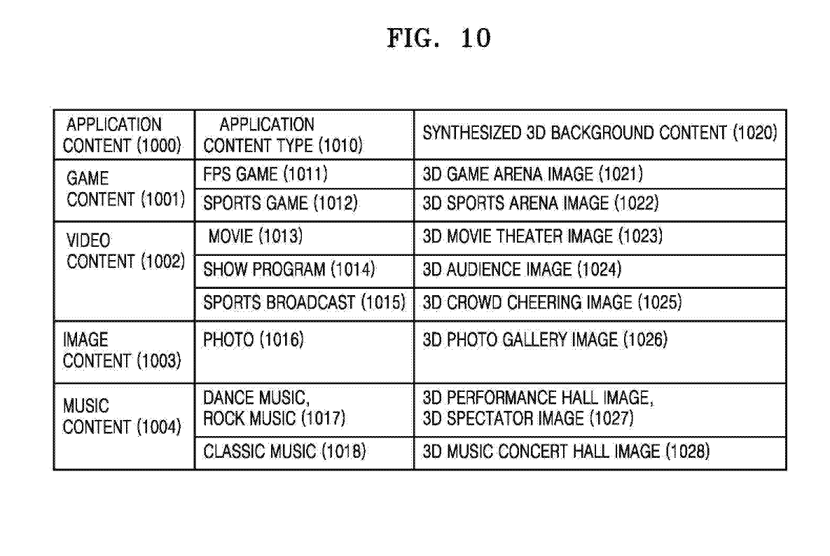

FIG. 10 is a diagram illustrating the relationship between application content and 3D background content synthesized by a device according to an embodiment of the present disclosure.

Referring to FIG. 10, application content 1000 received from the external device by the device may include game content 1001, video content 1002, image content 1003, and music content 1004. However, the application content 1000 is not limited thereto. In an embodiment of the present disclosure, the application content 1000 may be 2D non-stereoscopic content.

Each of the application content 1000 may also have different types of application content having different features. For example, the game content 1001 may include an FPS game 1011 and a sports game 1012. Likewise, the video content 1002 may include movie content 1013, show program content 1014, and sports broadcast content 1015; the image content 1003 may include photo content 1016; and the music content 1004 may include dance music content 1017 and classic music content 1018.

In an embodiment of the present disclosure, 3D background content 1020 synthesized with the application content may include a 3D stereoscopic image and a 3D stereoscopic video. The 3D background content 1020 may be stored in the memory 230 or 920 (see FIG. 2 or 9) of the device. In an embodiment of the present disclosure, the 3D background content 1020 may be stored in the external data server. For example, the 3D background content 1020 may include, but is not limited to, a 3D game arena image 1021, a 3D sports arena image 1022, a 3D movie theater image 1023, a 3D audience image 1024, a 3D crowd cheering image 1025, a 3D photo gallery image 1026, a 3D performance hall image 1027, and a 3D music concert hall image 1028.

The device may analyze an application content feature including at least one of the type of an application executing the application content, the number of image frames included in the application content, a frame rate, and information about whether a sound is output, recognize the type of the application content, and synthesize the 3D background content suitable for the application based on the type of the application content.

For example, when receiving the FPS game 1011 among the game content 1001 from the external device, the device may recognize the feature of the FPS game 1011 by analyzing the frame rate and the number of frames per second included in the FPS game 1011, and select the 3D game arena image 1021 based on the recognized feature of the FPS game 1011. The device may receive the selected 3D game arena image 1021 from the memory or the external data server and synthesize the received 3D game arena image 1021 and the FPS game 1011.

Likewise, when receiving the movie content 1013 among the video content 1002 from the external device, the device may recognize the movie content 1013 by analyzing the frame rate, the number of image frames of the movie content 1013, and information about whether a sound is output, and select the 3D movie theater image 1023 suitable for the movie content 1013. The device may synthesize the selected 3D movie theater image 1023 and the movie content 1013. FIG. 10 illustrates the relationship between the 3D background content 1020 and the application content type 1010 synthesized with each other. Thus, detailed descriptions of combinations of all the 3D background content 1021 to 1028 and all the application content 1011 to 1018 will be omitted herein.

In the embodiment of the present disclosure illustrated in FIG. 10, the device may recognize the application content type 1010 received from the external device, select the 3D background content 1020 suitable therefor, and synthesize the same and the application content. Thus, the device according to an embodiment of the present disclosure may provide the user with a 3D immersion effect and a 3D reality effect suitable for the application content 1000 that is being viewed by the user.

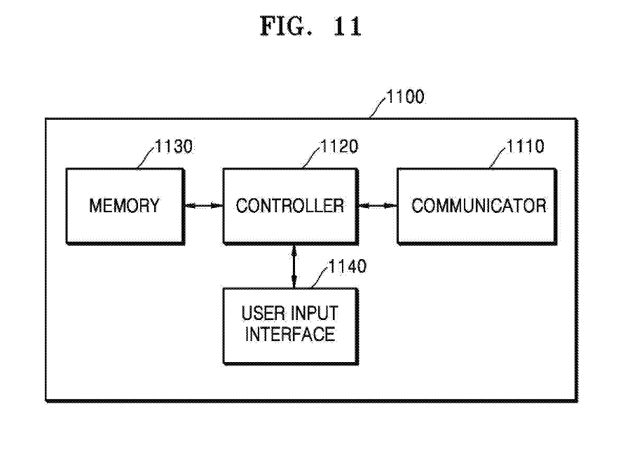

FIG. 11 is a block diagram of a device 1100 according to an embodiment of the present disclosure.

Referring to FIG. 11, the device 1100 may include a communicator 1110, a controller 1120, a memory 1130, and a user input interface 1140. Since the communicator 1110, the controller 1120, and the memory 1130 are the same as the communicator 210, the controller 220, and the memory 230 illustrated in FIG. 2, redundant descriptions thereof will be omitted for conciseness. The user input interface 1140 will be mainly described below.

The user input interface 1140 may receive a user input for selecting the 3D background content stored in the memory 1130 of the device 1100. The user input interface 1140 may include, but is not limited to, at least one of a touch pad operable by a user's finger and a button operable by a user's push operation.

In an embodiment of the present disclosure, the user input interface 1140 may receive a user input including at least one of a mouse input, a touch input, and an input gesture. The user input interface 1140 may include, but is not limited to, at least one of a mouse, a touch pad, an input gesture recognizing sensor, and a head tracking sensor.

In an embodiment of the present disclosure, the user input interface 1140 may receive at least one of a user input of touching the touch pad, a user input of rotating a mouse wheel, a user input of pushing the button, and a user input based on a certain gesture. Herein, the gesture may refer to a shape represented by a user's body portion at a certain time point, a change in the shape represented by the body portion for a certain time period, a change in the position of the body portion, or a movement of the body portion. For example, the gesture-based user input may include a user input such as a movement of the user's head beyond a preset range at a certain time point, or a movement of the user's finger by more than a preset distance.

The user input interface 1140 may receive a user input for selecting at least one of the 3D background content including the 3D stereoscopic video and the 3D stereoscopic image. In an embodiment of the present disclosure, the 3D background content may include a 3D stereoscopic model and a 3D stereoscopic frame for the application content. The 3D model may be an image for providing a 3D immersion environment of the user for the application. The 3D background content may be provided variously according to the application content types (see FIG. 10).

The 3D background content may be stored in the memory 1130. That is, in an embodiment of the present disclosure, the 3D stereoscopic image, the 3D stereoscopic video, the 3D stereoscopic frame, and the 3D stereoscopic model may be stored in the memory 1130, and the user input interface 1140 may receive a user input for selecting at least one of the 3D stereoscopic image, the 3D stereoscopic video, the 3D stereoscopic frame, and the 3D stereoscopic model stored in the memory 1130. However, the present disclosure is not limited thereto. For example, the 3D background content may be stored in the external data server (e.g., a cloud server), and the 3D background content selected by the user input interface 1140 may be received through the communicator 1110 by the device 1100.

The controller 1120 may synthesize the application content and the 3D background content selected based on the user input received by the user input interface 1140.

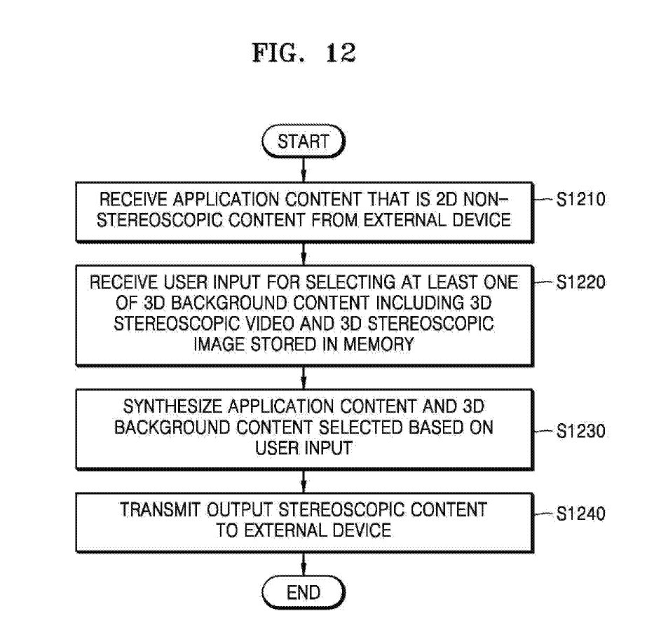

FIG. 12 is a flow diagram illustrating a method for synthesizing, by a device, 3D background content and application content, according to an embodiment of the present disclosure.

In operation S1210, the device may receive application content that is 2D non-stereoscopic content from an external device. In an embodiment of the present disclosure, the device may receive the application content from the external device connected to the device wirelessly and/or by wire. Since the external device and the application content are the same as those described in operation S310 of FIG. 3, redundant descriptions thereof will be omitted for conciseness.

In operation S1220, the device may receive a user input for selecting at least one of the 3D background content including the 3D stereoscopic video and the 3D stereoscopic image stored in the memory. In an embodiment of the present disclosure, the 3D background content may include at least one of the 3D stereoscopic image, the 3D stereoscopic video, the 3D stereoscopic frame, and the 3D stereoscopic model. In an embodiment of the present disclosure, the 3D background content may be stored in the memory 1130 (see FIG. 11), but the present disclosure is not limited thereto. In an embodiment of the present disclosure, the 3D background content may be stored in the external data server. The device may receive at least one user input among a mouse input, a touch input, and a gesture input, and select at least one of the 3D background content based on the received user input. When the 3D background content is stored in the memory, the device may receive the 3D background content from the memory; and when the 3D background content is stored in the external data server, the device may receive the 3D background content from the external data server through the communicator.

In operation S1230, the device may synthesize the application content and the 3D background content selected based on the user input. The device may dispose the application content to be displayed in the first region of the display of the external device and dispose the 3D background content to be displayed in the second region of the display of the external device.

In operation S1240, the device may transmit the output stereoscopic content to the external device. The output stereoscopic content may include the application content and the 3D stereoscopic content. The external device may receive the output stereoscopic content from the device, display the application content among the output stereoscopic content in the first region of the display, and display the 3D background content in the second region of the display.

In the embodiment of the present disclosure illustrated in FIGS. 11 and 12, since the device 1100 may synthesize the application content and the 3D background content selected directly by the user, it may directly provide a customized 3D immersion effect desired by the user. According to the embodiment of the present disclosure, the user viewing the output stereoscopic content through the external device may enjoy a desired 3D immersion effect according to the user's preference or choice.

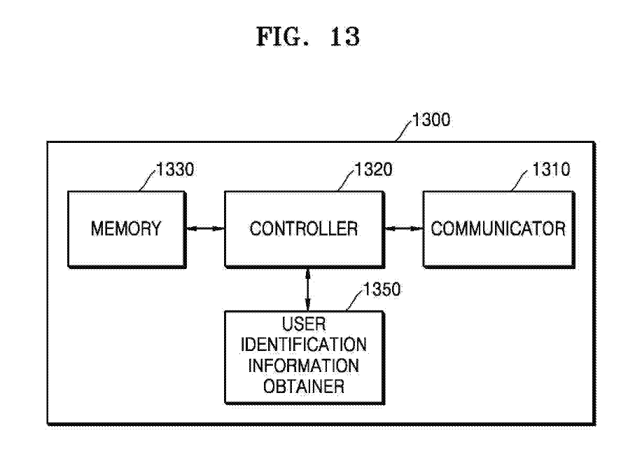

FIG. 13 is a block diagram of a device 1300 according to an embodiment of the present disclosure.

Referring to FIG. 13, the device 1300 may include a communicator 1310, a controller 1320, a memory 1330, and a user identification information obtainer 1350. Since the communicator 1310, the controller 1320, and the memory 1330 are the same as the communicator 210, the controller 220, and the memory 230 illustrated in FIG. 2, redundant descriptions thereof will be omitted for conciseness. The user identification information obtainer 1350 will be mainly described below.

The user identification information obtainer 1350 may include at least one of a voice recognition sensor, a gesture recognition sensor, a fingerprint recognition sensor, an iris recognition sensor, a face recognition sensor, and a distance sensor. The user identification information obtainer 1350 may obtain the identification information of the user using the external device connected to the device 1300, and identify the user based on the obtainer identification information. The user identification information obtainer 1350 may be located near the display of the external device connected to the device 1300, but the present disclosure is not limited thereto.

In an embodiment of the present disclosure, the user identification information obtainer 1350 may obtain the identification information of the user through at least one of the voice, iris, fingerprint, face contour, and gesture of the user using the external device connected to the device 1300. The user identification information may include personal information about the user using the external device, information about the application content used frequently by the identified user, and information about the type of the 3D background content synthesized with the application content by the identified user.

The controller 1320 may select the 3D background content based on the user identification information obtained by the user identification information obtainer 1350, and synthesize the selected 3D background content and the application content. The 3D background content may be stored in the memory 1330. That is, in an embodiment of the present disclosure, the 3D stereoscopic image, the 3D stereoscopic video, the 3D stereoscopic frame, and the 3D stereoscopic model may be stored in the memory 1330, and the controller 1320 may select at least one of the 3D stereoscopic image, the 3D stereoscopic video, the 3D stereoscopic frame, and the 3D stereoscopic model stored in the memory 1330, based on the user identification information obtained by the user identification information obtainer 1350, for example, the information of the 3D background content synthesized according to the application content used frequently by the user. The controller 1320 may synthesize the application content and the 3D background content selected based on the obtained user identification information.

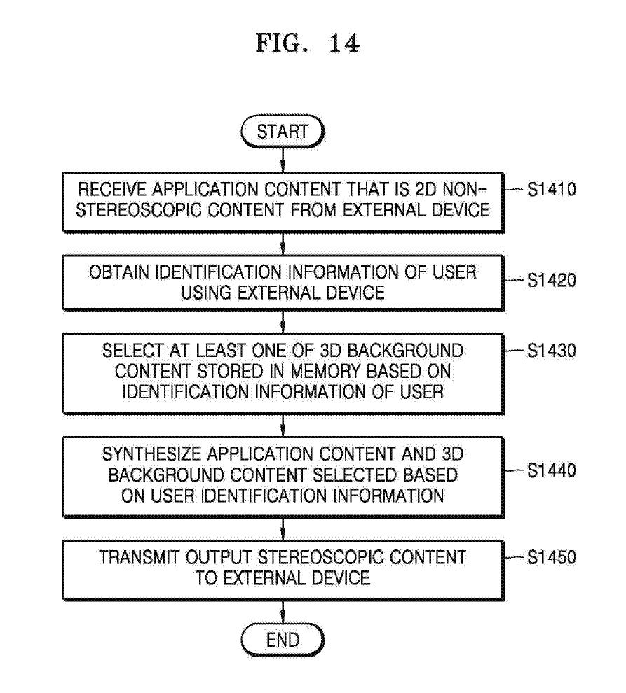

FIG. 14 is a flow diagram illustrating a method for synthesizing, by a device, 3D background content and application content based on the identification information of a user using the device, according to an embodiment of the present disclosure.

In operation S1410, the device may receive application content that is 2D non-stereoscopic content from an external device. In an embodiment of the present disclosure, the device may receive the application content from the external device connected to the device wirelessly and/or by wire. Since the external device and the application content are the same as those described in operation S310 of FIG. 3, redundant descriptions thereof will be omitted for conciseness.

In operation S1420, the device may obtain the identification information of the user using the external device. In an embodiment of the present disclosure, the device may obtain the identification information of the user through at least one of the voice, iris, fingerprint, face contour, and gesture of the user using the external device connected to the device. The user identification information may include, for example, personal information about the user using the external device, information about the application content used frequently by the identified user, and information about the type of the 3D background content synthesized with the application content by the identified user.

In operation S1430, the device may select at least one of the 3D background content stored in the memory, based on the user identification information. In an embodiment of the present disclosure, the 3D background content may include at least one of the 3D stereoscopic image, the 3D stereoscopic video, the 3D stereoscopic frame, and the 3D stereoscopic model, and the 3D background content may be stored in the internal memory of the device. The device may select at least one of the 3D stereoscopic image, the 3D stereoscopic video, the 3D stereoscopic frame, and the 3D stereoscopic model stored in the memory, based on the obtained user identification information, for example, the information of the 3D background content synthesized according to the application content used frequently by the user.

However, the 3D background content is not limited as being stored in the memory. In another embodiment of the present disclosure, the 3D background content may be stored in the external data server. When the 3D background content is stored in the external data server, the device may select the 3D background content from the external data server based on the user identification information, and receive the selected 3D background content from the external data server.

In operation S1440, the device may synthesize the application content and the 3D background content selected based on the user identification information. In an embodiment of the present disclosure, for example, the device may synthesize the application content and at least one of the 3D stereoscopic image, the 3D stereoscopic video, the 3D stereoscopic frame, and the 3D stereoscopic model selected based on the obtained user identification information, for example, the information of the 3D background content synthesized according to the application content used frequently by the user.

In operation S1450, the device may transmit the output stereoscopic content to the external device. The output stereoscopic content may include the application content and the 3D stereoscopic content. The external device may receive the output stereoscopic content from the device, display the application content among the output stereoscopic content in the first region of the display, and display the 3D background content in the second region of the display.

In the embodiment of the present disclosure illustrated in FIGS. 13 and 14, the device 1300 may provide a particular 3D immersion effect to the user by obtaining the user identification information and automatically selecting the application content used frequently by the user, or the 3D background content synthesized frequently with the application content by the user.

Each embodiment of the present disclosure may also be implemented in the form of a computer-readable recording medium including instructions executable by a computer, such as program modules executed by a computer. The computer-readable recording medium may be any available medium accessible by a computer and may include all of volatile or non-volatile mediums and removable or non-removable mediums. Also, the computer-readable recording medium may include all of computer storage mediums and communication mediums. The computer storage mediums may include all of volatile or non-volatile mediums and removable or non-removable mediums that are implemented by any method or technology to store information such as computer-readable instructions, data structures, program modules, or other data. For example, the communication mediums may include any information transmission medium and may include other transmission mechanisms or other data of modulated data signals such as carriers, computer-readable instructions, data structures, or program modules.

The foregoing is merely illustrative of the various embodiments, and the present disclosure is not limited thereto. Although the various embodiments of the present disclosure have been described above, those of ordinary skill in the art will readily understand that various modifications are possible in the various embodiments without materially departing from the spirits and features of the present disclosure. Therefore, it is to be understood that the various embodiments of the present disclosure described above should be considered in a descriptive sense only and not for purposes of limitation. For example, elements described as being combined may also be implemented in a distributed manner, and elements described as being distributed may also be implemented in a combined manner.

Therefore, the scope of the present disclosure is defined not by the detailed description of the embodiments but by the appended claims, and all modifications or differences within the scope should be construed as being included in the present disclosure.

It should be understood that embodiments described herein should be considered in a descriptive sense only and not for purposes of limitation. Descriptions of features or aspects within each embodiment should typically be considered as available for other similar features or aspects in other embodiments.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for synthesizing three-dimensional (3D) background content and application content by a device, the method comprising:
receiving the application content from an external device connected to the device, wherein the application content comprises two dimensional (2D) non-stereoscopic content;
generating output stereoscopic content by synthesizing the application content and the 3D background content including at least one of a 3D stereoscopic video and a 3D stereoscopic image; and
transmitting the generated output stereoscopic content to the external device,
wherein the generating of the output stereoscopic content comprises disposing the application content to be displayed in a first region of a display of the external device and disposing the 3D background content to be displayed in a second region of the display.

2. The method of claim 1, wherein the generating of the output stereoscopic content comprises disposing the 3D background content to surround the application content.

3. The method of claim 1, wherein the 3D background content includes at least one stereoscopic virtual reality (VR) image among a 3D game arena image, a 3D movie theater image, a 3D photo gallery image, a 3D music performance hall image, and a 3D sports arena image.

4. The method of claim 1, further comprising identifying a device type of the external device,
wherein the synthesizing of the 3D background content comprises adding at least one of the 3D stereoscopic video and the 3D stereoscopic image to the application content based on the identified device type of the external device.

5. The method of claim 4,
wherein the external device comprises a head-mounted display (HMD) device,
wherein the external device is identified as the HMD device, and
wherein the generating of the output stereoscopic content comprises:
rendering the application content such that a frame of the application content has a same shape as a lens of the HMD device;
disposing the rendered application content in the first region corresponding to the lens among an entire region of the display of the HMD device; and
disposing the 3D background content in the second region other than the first region among the entire region of the display.

6. The method of claim 4,
wherein the external device comprises a 3D television (TV),
wherein the external device is identified as the 3D TV, and
wherein the generating of the output stereoscopic content comprises:
performing a first rendering to convert the application content into 3D application content; and
performing a second rendering to convert the 3D application content such that the converted 3D application content is displayed in the first region of the display of the 3D TV.

7. The method of claim 1, further comprising:
analyzing an application content feature including at least one of an application type executing the application content, a number of image frames included in the application content, a frame rate, and information about whether a sound is output,
wherein the generating of the output stereoscopic content comprises synthesizing the application content and at least one of the 3D stereoscopic video and the 3D stereoscopic image corresponding to the application content, based on the analyzed application content feature.

8. The method of claim 1,
wherein the 3D background content is stored in a memory of the device, and
wherein the generating of the output stereoscopic content comprises:
selecting at least one of the 3D background content among the 3D stereoscopic video and the 3D stereoscopic image stored in the memory; and
synthesizing the selected 3D background content and the application content.

9. The method of claim 8, further comprising:
receiving a user input for selecting at least one of the 3D stereoscopic video and the 3D stereoscopic image stored in the memory,
wherein the generating of the output stereoscopic content comprises synthesizing the application content and the 3D background content selected based on the user input.

10. A device for synthesizing three-dimensional (3D) background content, the device comprising:
a communicator configured to receive application content from an external device connected to the device, wherein the application content comprises two dimensional (2D) non-stereoscopic content; and
a controller configured to:
generate output stereoscopic content by synthesizing the application content and the 3D background content including at least one of a 3D stereoscopic video and a 3D stereoscopic image,
dispose the application content to be displayed in a first region of a display of the external device, and
dispose the 3D background content to be displayed in a second region of the display,
wherein the communicator transmits the generated output stereoscopic content to the external device.

11. The device of claim 10, wherein the controller disposes the 3D background content in the second region surrounding the first region.

12. The device of claim 10, wherein the 3D background content includes at least one stereoscopic virtual reality (VR) image among a 3D game arena image, a 3D movie theater image, a 3D photo gallery image, a 3D music performance hall image, and a 3D sports arena image.

13. The device of claim 10, wherein the controller identifies a device type of the external device, and the 3D background content is synthesized by adding at least one of the 3D stereoscopic video and the 3D stereoscopic image to the application content based on the identified device type of the external device.

14. The device of claim 13,
wherein the external device comprises a head-mounted display (HIVID) device,
wherein the external device is identified as the HMD device, and
wherein the controller is further configured to:
render the application content such that a frame of the application content has a same shape as a lens of the HMD device,
dispose the rendered application content in the first region corresponding to the lens of the HMD device among an entire region of the display of the HMD device, and
dispose the 3D background content in the second region other than the first region among the entire region of the display of the HMD device.

15. The device of claim 13,
wherein the external device comprises a 3D television (TV),
wherein the external device is identified as the 3D TV, and
wherein the controller is further configured to:
perform a first rendering to convert the application content into 3D application content, and
perform a second rendering to convert the 3D application content such that the converted 3D application content is displayed in the first region of the display of the 3D TV.

16. The device of claim 10, wherein the controller is further configured to:
analyze an application content feature including at least one of an application type executing the application content, a number of image frames included in the application content, a frame rate, and information about whether a sound is output, and
synthesize the application content and at least one of the 3D stereoscopic video and the 3D stereoscopic image corresponding to the application content based on the analyzed application content feature.

17. The device of claim 10, further comprising a memory configured to store the 3D background content,
wherein the controller is further configured to:
select at least one of the 3D background content among the 3D stereoscopic video and the 3D stereoscopic image stored in the memory, and
synthesize the selected 3D background content and the application content.

18. The device of claim 17, further comprising:
a user input interface configured to receive a user input for selecting at least one of the 3D stereoscopic video and the 3D stereoscopic image stored in the memory,
wherein the controller synthesizes the application content and the 3D background content selected based on the user input.

19. A non-transitory computer-readable recording medium that stores a program that performs the method of claim 1 when executed by a computer.
